(19) United States
(12) Patent Application Publication
(10) Pub. No.: US 2003/0197577 A1
(43) Pub. Date: Oct. 23, 2003

(54) Single port delay element

(75) Inventor: Rafi Hershtig, Salisbury, MD (US)

Correspondence Address: BANNER & WITCOFF, 1001 G STREET N W, SUITE 1100, WASHINGTON, DC, 20001, US

(73) Assignee: K&L Microwave, Inc., Salisbury, MD (US)

(21) Appl. No.: 10/126,969

(22) Filed: Apr. 22, 2002

(51) Int. Cl. H01P 1/18; H01P 1/20

(52) U.S. Cl. 333/156; 333/202

(57) ABSTRACT

Aspects of the present invention include a novel delay system, and corresponding method, for increasing the natural delay of a system utilizing filters having only one port. Aspects of the present invention also involve a delay circuit utilizing one or more circulators. Yet further aspects of the invention involve providing a reflective surface for increasing the distance traversed thereby increasing delay. In a further aspect of the invention, multiple filters may be employed by coupling those filters through one or more circulators interchangeably, thereby creating a varying number of delay combinations, and thereby varying the cumulative delay times. In a further aspect of the invention, filter resonators may be arranged in arrays and may be coupled through opening in the cavities encasing the resonators. As an additional aspect of the invention, the resonator cavities of the filter may be cross-coupled. As yet a further aspect of the invention, the components of the circulator and filter combination may be contained within a single, unitary housing.

### FIELD OF THE INVENTION

Aspects of the present invention are directed generally to a system and method for delaying transmission signals, more particularly, aspects of the invention relate to a system and method of generating delay using one or more singly terminated band-pass filters.

### BACKGROUND

Delay lines ideally have a uniform, fixed amount of insertion delay and constant phase over a predetermined frequency range. These ideal objectives are difficult to achieve in high power applications and when generating long delays, e.g., delays in excess of a few nanoseconds, more particularly delays in excess of 15 nanoseconds, and preferably delays greater than 30 nanoseconds, even more preferably delays in excess of 50 ns.

One application in which the generation of long delays is desirable involves the testing of devices communicating over a wireless local area network, or “WLAN.” Such devices may include laptops, desktops, printers, cellular phones and similar devices. Incorporated in such devices are WLAN cards, which enable the devices to perform wireless communication.

Unfortunately, devices connected over a WLAN often receive multiple copies of the same signal as the signal is reflected off of walls or other surfaces in and around the area encompassed by the WLAN, which may be located in, for example, a home, a dormitory, a business or any number of settings. For example, the intended recipient, a printer, might receive the copy of a print command traveling the shortest distance first. As reflections of the print command also make their way to the printer, traveling paths of differing lengths, multiple copies of the print command might be received by the printer at times proportional to the distances traveled by those signals. The transmission of these multiple reflections of a signal is known as “multi-path propagation.” To function, the printer must be capable of distinguishing between signals properly received, and copies of previously received signals that are to be ignored.

Such aforementioned devices are typically designed to detect multi-path propagation and compensate for such communication error. WLANs often utilize a protocol, such as that defined by IEEE 802.11, to facilitate the communication between devices connected over the WLAN. Before these devices can be shipped by their manufacturer, however, they must be tested to insure they function properly. Thus, there is a need for an apparatus and method that can simulate the various environments and communication errors that a device may experience, so that it may be tested prior to sale. To simulate multi-path propagation, and the like, there is a need to realize long delays.

Efforts for producing optimum delay equalization techniques have been hindered by the fact that an increase in delay normally results in a loss of bandwidth. Moreover, an increase in the mathematical functions of a delay filter or filtering system requires an increased number of resonators for producing the desired delay. As the complexity of a filter increases, the practicality of manufacturing the device diminishes. Accordingly, a suitable delay circuit for yielding long delays without a substantial sacrifice of bandwidth, or a dramatic increase of costs, has not been realized.

Various attempts have been made to achieve delay equalization using active components to shift various delay response curves and add them together. In 1964, Dr. S. B. Cohn proposed using a four-port coupler or a three-port circulator to achieve equalization of non-linear phase angle or time delay characteristics of other components. See, for example, U.S. Pat. No. 3,277,403, herein incorporated by reference, and U.S. Pat. Nos. 4,197,514 and 4,988,962 citing examples of Dr. Cohn's earlier work. Over the years, there have been several attempts at implementing the structures suggested by Dr. S. B. Cohn through the use of bulky, costly, and large devices such as that found in the above-mentioned U.S. Pat. No. 3,699,480, describing a cavity filter circulator coupled to an impedance circuit.

None of these devices, however, has proven effective for yielding long delays. The system described in U.S. Pat. No. 3,699,480, for example, is bandwidth limited, in other words the linear component of the frequency response may persist for only a few nanoseconds. The portion of a curve for which the curve is somewhat linear is typically a very low percentage, often 1% of the overall curve, or less. Thus, such a device requires the use of a predistortion equalization stage or element to improve its response. Similarly, the invention disclosed in U.S. Pat. No. 4,988,962 also suffers from the inability of providing a flat response. Attempts to configure miniaturized implementations using the same designs employed in delay equalized cavity filters have thus far proved unsuccessful due to the cross coupling between the various lumped components of a filtering system.

### SUMMARY OF THE INVENTION

Aspects of the present invention involve a delay element including one or more single ported filters. Aspects of the invention also involve the generation of a long delay using only a single delay element and no predistortion stage. Further aspects of the present invention involve a delay element including a filter with a reflective component for redirecting an input signal. Aspects of the present invention also involve a delay circuit utilizing one or more circulators.

Aspects of the present invention further include a novel delay system, and corresponding method, for increasing the natural delay of a system utilizing filters having only one port. Further aspects of the invention involve coupling a circulator to a filter. Yet further aspects of the invention involve providing a reflective surface within the filter off of which signals may reflect such that they traverse a length of the filter multiple times. As a result, in this aspect of the invention, the single-terminated filter may at least double the nominal delay of the filter.

In a further aspect of the invention, multiple filters may be employed by coupling those filters with one or more circulators. As a further aspect of the invention, circulators may be used to control the transmission of signals from filter to filter. Additional aspects of the invention involve the use of filters and circulators that may be coupled interchangeably, thereby creating a varying number of delay combinations, and thereby varying the cumulative delay times. Moreover, aspects of the invention involve the use of delay elements having different delay times. These elements may be utilized to provide a greater degree of variance and, thereby, achieve a desired delay.

In a further aspect of the invention, the elements of the bandpass filter, the resonators, may be arranged linearly or in two-dimensional arrays. As an additional aspect of the invention, the resonator cavities of the filter may be cross-coupled. As a further aspect of the invention, the components of the circulator and filter combination may be contained within a single, unitary housing. As yet a further aspect of the invention, filters may be coupled directly to circulators without requiring terminals or connectors.

These and other features and aspects of the invention will be apparent upon consideration of the following detailed description of the preferred embodiments.

### BRIEF DESCRIPTION OF THE DRAWINGS

The foregoing summary and description of the preferred embodiments of the invention is intended to facilitate a better understanding of the invention, but is not intended to limit the scope of the invention.

The following represents brief descriptions of the drawings, wherein:

FIG. 1 shows an exemplary embodiment of the present invention.

FIG. 1A shows a cross-section of the embodiment of the invention illustrated in FIG. 1, including an illustrative arrangement of resonators and respective resonator cavities.

FIG. 2 illustrates a simplified flow diagram depicting the transmission of signals within the embodiment of the invention illustrated in FIG. 1A.

FIG. 3 shows a nominal delay response of a filter.

FIG. 4 shows a delay response of a single ported filter and circulator illustrated in the embodiment of the invention shown in FIG. 1A.

FIG. 5 shows a further example of the present invention.

FIG. 6 illustrates a flow diagram depicting the transmission of signals within the embodiment of the invention shown in FIG. 5.

FIG. 7 shows a delay response of the embodiment of the invention shown in FIG. 5.

FIG. 8 shows a proposed scheme for cascading an array of elements.

FIG. 9 shows a configuration wherein a circulator is connected to a filter having a two dimensional array of resonators wherein the filter is a single connector, singly terminated and phase equalized filter.

FIG. 9A shows a further example of the present invention including a further example of a filter having a two dimensional array of resonators.

FIG. 10 illustrates a flow diagram depicting the transmission of signals within the invention illustrated in FIG. 9.

In the following detailed description of the invention, it should be noted that, when appropriate, like reference numerals and characters may be used to designate identical, corresponding or similar components in differing figure drawings. Further, in the detailed description to follow, exemplary embodiments and values may be described, however, the present invention is not intended to be limited thereto.

### DETAILED DESCRIPTION OF PREFERRED EMBODIMENTS

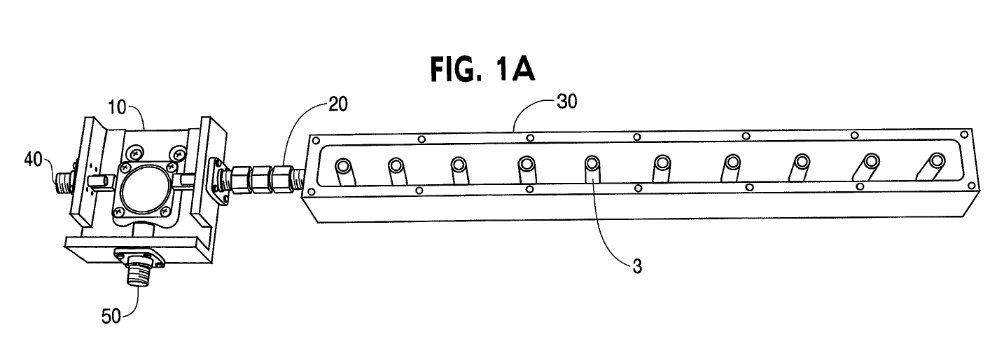

FIG. 1 shows an illustrative embodiment of the present invention. In particular, according to this example of the present invention, the system includes a circulator 10 coupled to a singly terminated delay element, filter 30, through port 20. Circulator 10 may be one of any of a number of such devices known in the art. Circulator 10 may include multiple ports or terminals, such as ports 40, 50, and the port coupled to port 20, and the device may be constructed such that that signals entering one port are transmitted in a desired direction to an adjacent port for output. The ports, including port 20, may be comprised of one or more terminals or connections, or may be comprised of an opening in a unitary chassis design surrounding the filter, the circulator, or both.

FIG. 1A shows, in relevant part, a cross-section of filter 30 of the embodiment of the invention illustrated in FIG. 1. In particular, the figure shows one possible internal construction of the filter, in this case including a linear array of resonators 3. Filter 30 may be a band-pass filter and may include a plurality of resonators as shown in FIG. 1A, but may be one of any number of filters and/or devices that may be configured to operate in a manner similar to that provided below. In a preferred embodiment, because a minimal amount of loss may be acceptable, metal resonators may be utilized thereby avoiding the cost associated with ceramic resonators. Moreover, the inventor has discovered that use of metal resonators is preferred over the use of ceramic resonators because the metal resonators exhibited more favorable cost and performance characteristics. Nevertheless, the use of ceramic resonators is within the scope of aspects of this invention.

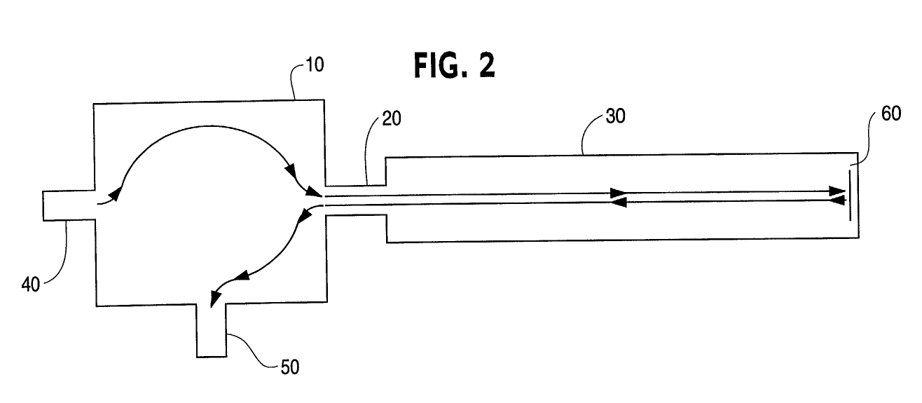

The filter may include a reflective element that may or may not be an integral part of the wall of the filter furthest from port 20. The reflective area may or may not be composed of, for example, a reflective wall or a radio frequency (RF) shield. For example, a resonator may be disposed at the end of filter 30 furthest from the single port and may include a reflective area 60 (shown in FIG. 2). However, the reflective area 60 may be provided at any location within the device in accordance with the desired effect and/or delay time.

FIG. 2 illustrates a flow diagram depicting the transmission of signals through circulator 10 and filter 30, and is intended only to illustrate the overall net effect of the transmission of signals through the circulator and the filter. FIG. 2 is not intended to depict the actual behavior of the signals as they travel through such devices or through the resonators of the filter of the exemplary embodiment described above.

As shown in FIG. 2, signals may be input to circulator 10 at a first port 40 and circulated to the second port of the circulator and output to port 20. The signals may be transmitted through port 20 and into filter 30. The signals may then be transmitted a length of the filter until they reach reflective element 60, at which time they may be reflected in the opposite direction and return the length of filter 30, exiting, for example, through port 20. Signals re-entering circulator 10 may be directed to the third port 50 of filter 30 and output.

Thus, a signal input to the first end of filter 30 may be transmitted along an axial direction of the filter 30 until it reaches the distal end thereof. The amount of time for the signal to travel from port 20 to the distal end of filter 30, hereafter identified as time T, is the natural time of delay for the filter. The amount of time required for the reflected signal to return the length of the filter to port 20 is also equal to time T. Thus, the amount of time that elapses from the time the signal is input to port 20 of the single terminal filter to the time the signal is output from port 20 may be about 2T. Accordingly, the singly terminated filter 30 illustrated in FIG. 1 essentially doubles the nominal delay of an input signal.

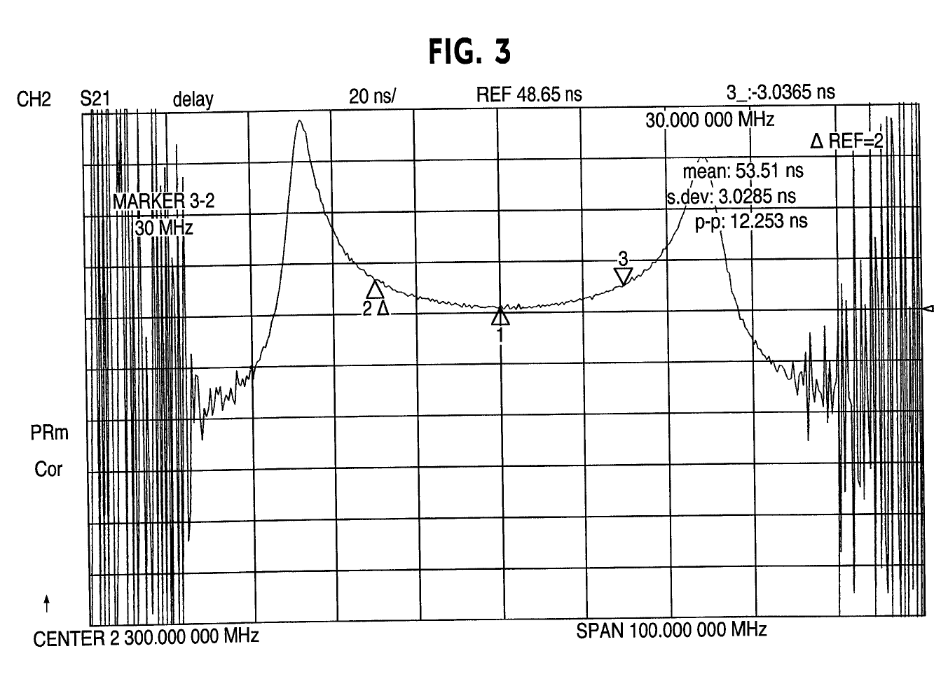

FIG. 3 shows a delay response of a filter lacking the doubling aspects of the reflective feature of the single port filter. As illustrated, the nominal delay of this filter is about 50 ns.

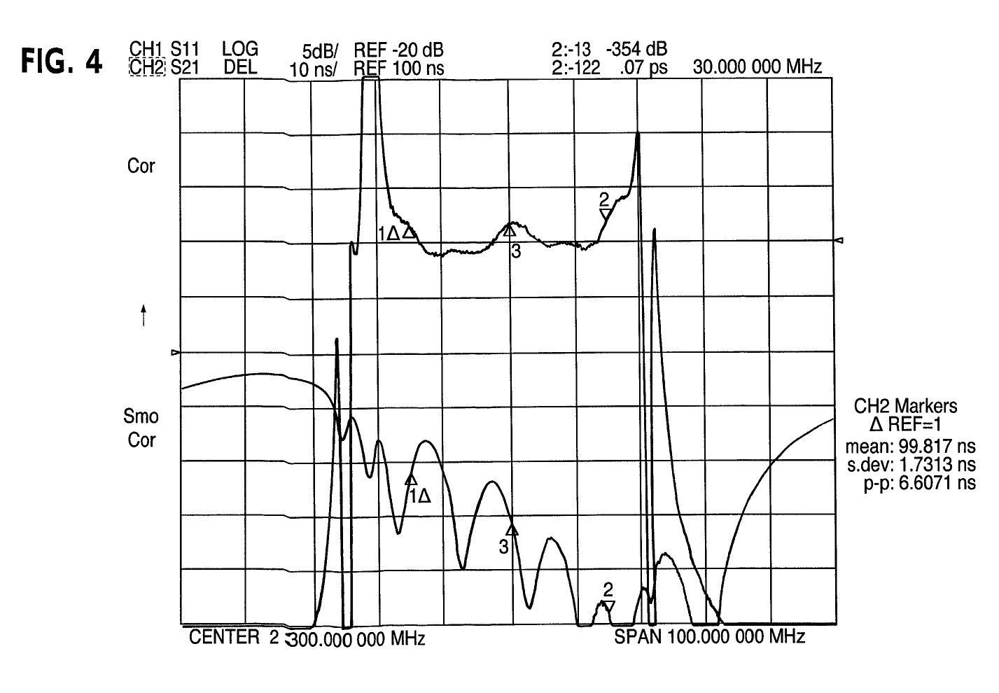

FIG. 4 shows a delay response representative of the single port filter and circulator configuration illustrated in the embodiment of the invention shown in FIG. 1A. The figure illustrates the long delay achieved while retaining an appropriate frequency response using aspects of the invention. Assuming use of a single port filter having a nominal delay response of about 50 ns, the delay response of the single port filter and circulator combination results in an increase in the delay of, in this example, twice of that of the filter, or about 100 ns, as shown in FIG. 4. This particular delay response was generated using a dummy connector on the terminal port of the single port filter.

In accordance with another embodiment of the invention, components may be added in various combinations to create the exact amount of delay desired. For example, a second filter may be coupled to the first circulator shown in FIG. 1 to further increase the delay by an additional time of 2T. The components of the system may be designed to be interchangeably “plugged in” or coupled together as desired.

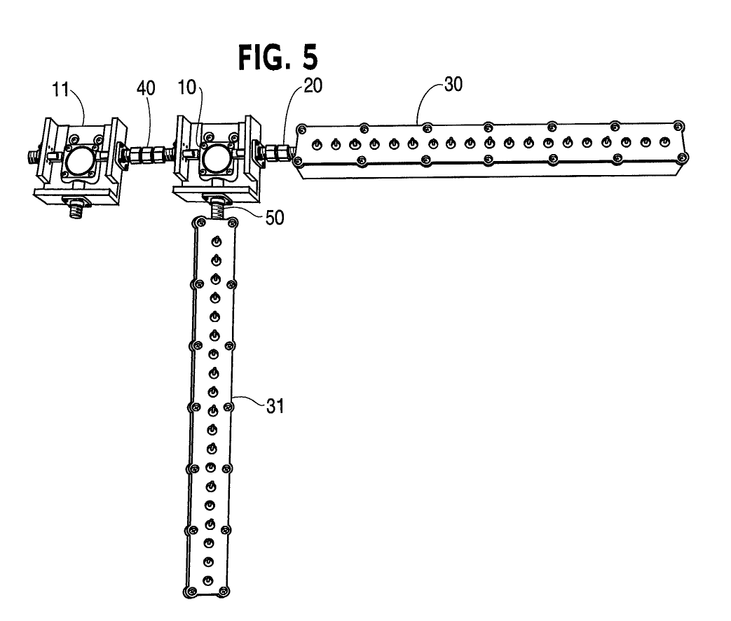

As shown in FIG. 5, additional circulators and/or filters may be connected to the circulator illustrated in FIG. 1. To reiterate, FIG. 1 shows a first circulator 10 that may be coupled through port 20 to a first filter 30. As shown in FIG. 5, a second filter 31 may be coupled to circulator 10 through port 50. First port 40 may couple circulator 10 to additional circulator 11. Operation of this exemplary system utilizing plural filters, in a simplified depiction of the transmission of signals within the various components, follows.

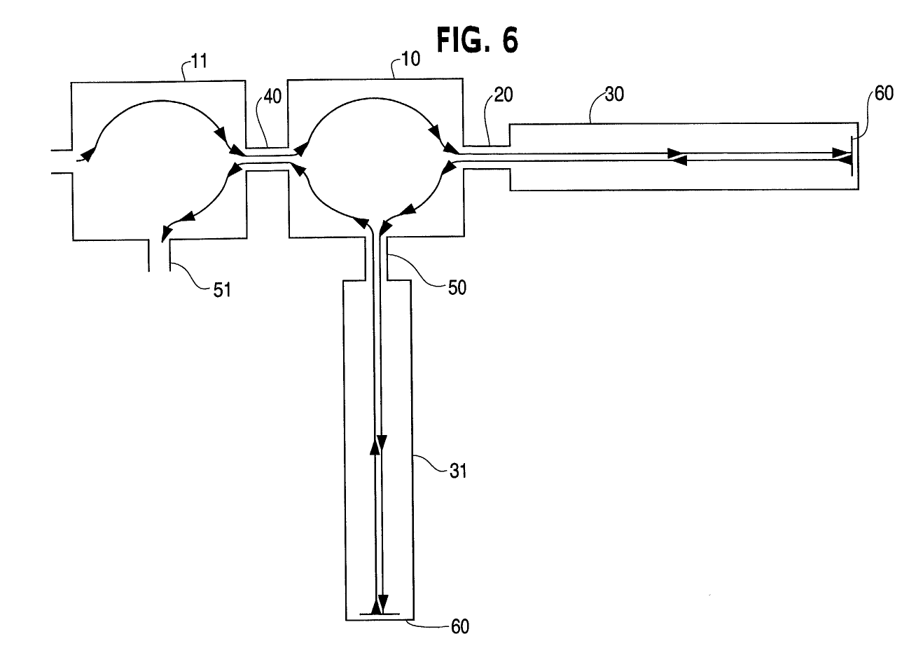

FIG. 6 illustrates a flow diagram depicting the transmission of signals within the embodiment of the invention shown in FIG. 5. As illustrated in FIG. 6, signals entering the first port of circulator 11 (located on the left side of the circulator) may be directed in a clock-wise manner to the second port (right most port of the circulator, as illustrated). Signals may be output from circulator 11 and may be input to circulator 10 through the first port of circulator 10 (also located on the left side of the circulator). Such input signals may then be directed in a clock-wise manner to the second port (also the right most port of the circulator, as illustrated) and may be output through port 20 to filter 30. Having reached port 20 of filter 30, the signals may traverse a length of the filter and may then be reflected by a reflective surface 60 located at the distal end of the filter. The reflected signals may again traverse the length of the filter until exiting the filter through port 20. The signals output from filter 30 next may reenter circulator 10.

Signals input to circulator 10 from filter 30 may be directed by the circulator in a clockwise direction and such that they exit the circulator through port 50. These signals may then enter single ported filter 31 and may traverse a length of this filter. Next, the signals may be reflected by reflective surface 60 of filter 31 and returned an equal distance. The reflected signals may be output from the filter through the same port from which they entered, and may be transmitted to circulator 10 through port 50. Next the signals may be directed to port 40 of circulator 10 and output to circulator 11. In circulator 11, the signals may be redirected to port 51 from which they may be output.

Filter 30 and filter 31 each add a delay, 2T, which may substantially equal to twice the normal delay required for the signals to traverse the length of an individual filter. Cumulatively, the delay realized as a result of the signals traversing both filters about equals the sum of the delay attributable to each individual filter, or 4T. Of course, while the above illustrative embodiment of the invention has been described as employing two filters having identical delay characteristics, this description of the invention is not intended to limit the scope of the invention to the use of only two filters or to the use of filters having identical delay characteristics. The use of any number of filters, varying types of filters, or any similar devices, is well within the scope of aspects of the present invention. Indeed, the use of elements or combination of elements functioning in any similar manner for generating delay is well within the scope of aspects of the present invention.

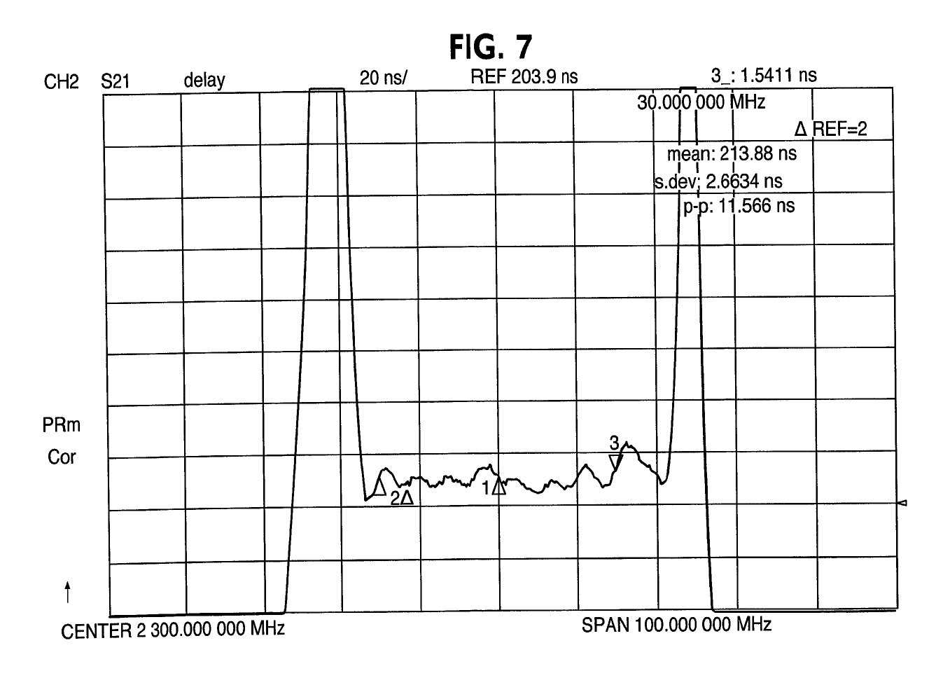

FIG. 7 shows a delay response of the embodiment of the invention shown in FIG. 5, illustrating that by increasing the number of filters, an even greater amount of delay may be achieved while retaining an appropriate frequency response. In this illustration, assuming the use of single port filters having delay responses of about 100 ns, the combined delay response would be about 200 ns.

In a further exemplary embodiment, filters may be coupled in a long cascade configuration through an array of circulators coupled in series. In this example, each circulator may be coupled to an adjacent circulator on either side, and to an additional filter at an available port. For each filter added to the system, the delay increases by an amount that may substantially equal time 2T, assuming that filters having identical characteristics are used.

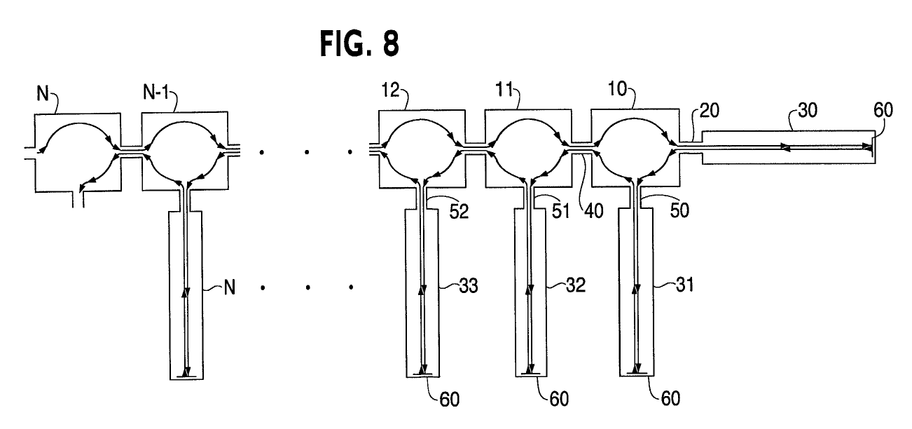

FIG. 8 incorporates the elements and the configuration of elements of the embodiment illustrated in FIG. 6. FIG. 8 further includes additional circulators (12 through N) and illustrates that the circulators may be coupled to one another in series through respective first and second ports. Thus, each adjacent circulator in the series of N circulators may be coupled in a like manner.

In accordance with this proposed scheme for cascading an array of elements, each additional circulator may be further coupled to an additional filter (although circulator N of FIG. 8 is not shown coupled to a filter, because circulator 11 has been coupled with filter 32, the number of additional filters in this illustration is N-2). Filters may be coupled to respective circulators at an available port, or any port not occupied by an adjacent circulator. In this embodiment, with the exception of the Nth circulator, which may output the delayed signal from a third port illustrated as the bottom most port, the remaining circulators may each be coupled to at least one filter. Each single ported filter may include a reflective region located at a length along the filter.

A simplified depiction of the operation of an exemplary system utilizing a cascaded array of circulators and filters follows. The elements illustrated in this embodiment, as seen in FIG. 8, that are also shown in the embodiment depicted in FIG. 6 may function in essentially the same manner described with respect to the embodiment illustrated in FIG. 6, to the extent the figures are identical. In the embodiment depicted in FIG. 8, however, input signals may traverse a greater number of circulators, ports and single ported filters.

As illustrated in FIG. 8, signals entering the first port of each circulator may be directed to the second port. Thus, those signals may traverse each of the circulators. Signals reaching port 20 of filter 30, may traverse a length of the filter and may be reflected by a reflective surface located within the filter. The reflected signals may return the length of the filter until they exit through port 20.

Signals output from filter 30 may next be directed by circulator 10 in a clockwise direction and may exit the circulator through port 50. Those signals may then enter single ported filter 31 and traverse a length of this filter until they reach the distal end. At such time, they may be reflected and caused to return the length of the filter.

The signals may then exit filter 31 through port 50 and may be directed in a clockwise manner to the first port 40 of circulator 10. Those signals may then be input to adjacent circulator 11. Such signals may then be directed in a clockwise manner by circulator 11 to port 51, thereby entering filter 32. In a similar manner to that describe previously, the signals may traverse the length of filter 32 twice before reentering circulator 11, from which they may be output. This cycle of transmitting signals such that they may enter a circulator from an adjacent circulator, may exit the last circulator and may enter a remaining single-ported filter, may traverse the length of the filter twice, and may return to the circulator for re-direction to an adjoining circulator, may be repeated until the last filter is traversed. At such a time, the signals entering the last circulator (Nth) from the last filter (Nth) may be output from that circulator.

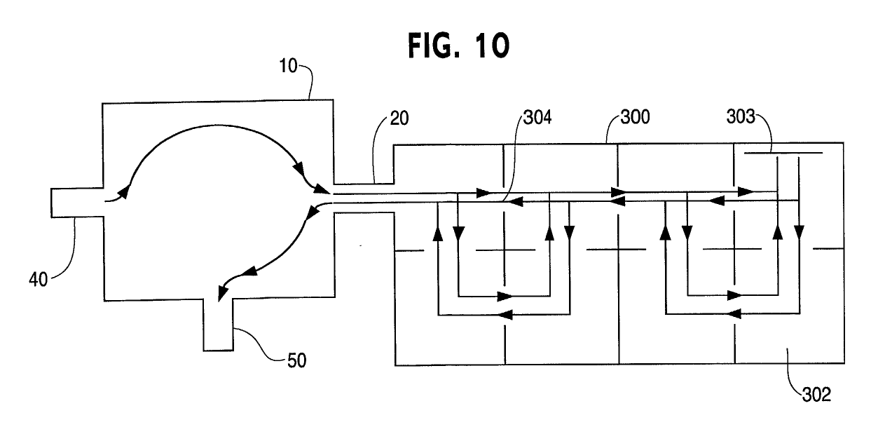

As illustrated in this exemplary embodiment, the amount of delay may increase by 2T for each of the N filters added to the system. Accordingly, the cumulative delay of the exemplary embodiment illustrated in FIG. 10 may equal N×2T, assuming that each filter has an identical delay characteristic. Because the components may be interchangeable, filters having unequal delay may be utilized to generate cumulative delays having non-integer multiples of delay 2T. Moreover, the number of circulators and filters may be adjusted by adding or removing components as necessary to achieve a desired delay.

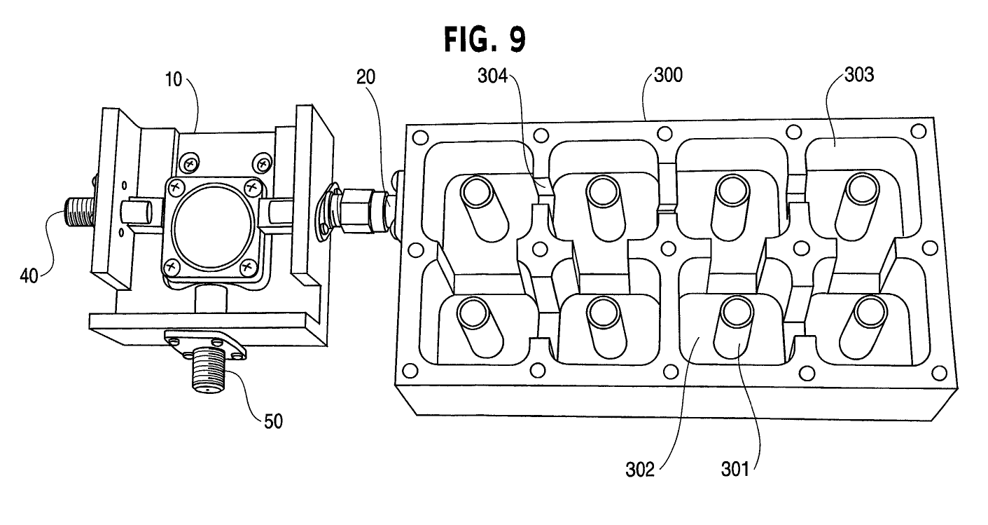

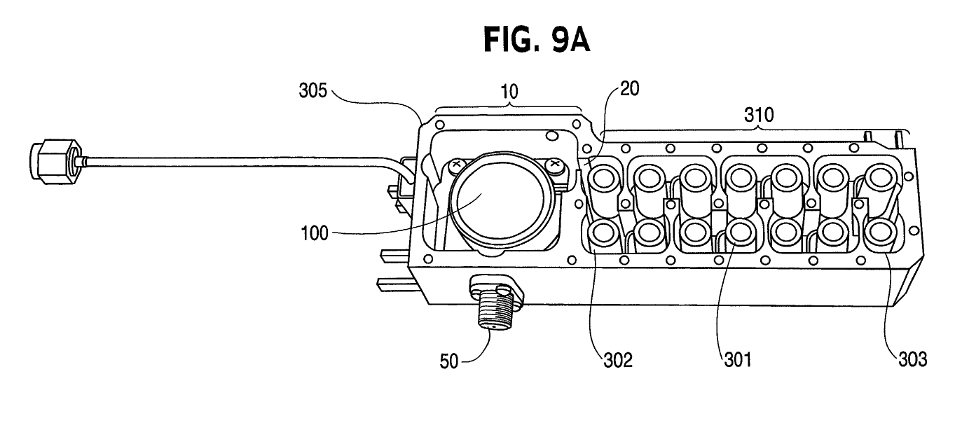

FIG. 9 shows a cross section of yet a further example of the present invention, one including a circulator and a filter. Filter 300 is constructed having a two dimensional array of resonators. The filter may be a bandpass filter, and may more specifically be comprised of a single connector, singly terminated and phase equalized bandpass filter. To facilitate the transmission of signals through the filter, each resonator 301 may be located within a respective resonator cavity 302. The resonator cavities may include walls formed as an integral part of filter chassis 300, of course, numerous techniques are known in the art and can be used in the construction of these cavities. Each cavity, with the exception of the first and last, may include at least two main openings, as illustrated in FIG. 9, through which input signals may traverse. The cavity walls direct the signals through these openings to an adjacent resonator cavity. The first cavity may include only one main opening to an adjacent cavity on one side, and port 20 on another. The last cavity, one of two cavities located furthest from port 20, may include a main opening on one side and a wall on each of the other three sides. The signals entering the last cavity must be redirected such that the signals traverse a distance greater than the length of the filter. Thus, in the example of the embodiment illustrated in FIG. 9, the signals may be redirected off of the reflective area 30 comprised of, for example, a wall or walls, and reflected through an opening. The reflected signals may then return the same path initially traversed and may exit the filter through port 20.

FIG. 9A shows a cross section of yet a further example of the present invention including a further example of a filter having a two dimensional array of resonators. In this example, the filter is contained within a unitary chassis design along with the circulator element. In this exemplary embodiment, resonators 301 and circulator element 100 are encased within a single chassis 305. Filter 310 includes resonators 301 encased on three sides by at least portions of the exterior of chassis 305, and by an interior wall shared with circulator element 100. The remaining three sides of circulator element 100 are bounded by the remaining portions of the exterior walls of chassis 305, as illustrated.

As further illustrated in FIG. 9A, circulator element 100 may be coupled to filter 310 through an opening formed in the shared interior wall of chassis 305. In this embodiment, port 20 may be simply an opening formed in, or cut into, an interior wall of the unitary chassis 305. As a result, no terminal would be required for coupling circulator element 100 to filter 310. By avoiding use of a terminal for coupling the circulator to the filter, the signal loss is greatly reduced. Furthermore, manufacturing costs may be reduced using a unitary construction design.

FIG. 10 illustrates a flow diagram depicting the transmission of signals within the embodiment of the invention illustrated in FIG. 9. As previously described, the signals may be input to filter 300 through port 20. The signals traverse the filter through the openings in filter cavities 302. In this illustrative embodiment, signals travel through the larger openings in the cavities in a S-shaped pattern, given the alignment of the openings depicted in the figure. The signals travel through each of the filter cavities 302 until they reach the last cavity, at which time they may be reflected and returned to port 20 as previously described.

Of course, the signals may alternatively reflect off the resonator located within the last cavity, or any suitable method of reflection may be employed. Moreover, within the last filter the signals may be redirected to port 20 of the filter by any means, so long as the signals traverse a length substantially greater than one time the length of the filter, and thereby may be delayed a time greater than the natural delay of the filter (T).

While the illustrated embodiment depicted in FIGS. 9 and 9A shows main openings between cavities, arranged in this example in S-shaped patterns, through which the input signals may be transmitted, the configuration of the resonator cavities may be constructed to further include additional openings 304 between cavities, as shown in FIG. 9. These additional openings between cavities enable cross coupling of the resonator cavities. Such cross coupling of resonator cavities enhances the linearity of the curve of the filter, and therefore, provides a longer delay. FIG. 10 illustrates the transmission of signals through the additional openings, the cross-coupling of cavities, as lines passing from cavity to cavity horizontally, in this depiction.

While the illustrated embodiment shows a particular arrangement of resonators and resonator cavity openings, and a specific number of such components, the invention is not to be limited to this illustrative embodiment as numerous variations and modifications to this design is and would be well within the scope of this invention. For example, in the embodiments illustrated, the filter includes at least a two dimensional array of resonators, but may include any number or arrangement of resonators. Moreover, the unitary chassis design may be modified in a number of ways while remaining within the scope of the invention.

While the embodiment shown in FIGS. 9 and 9A depicts the arrangement of the main openings between cavities in S-shaped patterns, the configuration of the resonator cavities and their respective openings may be configured in a variety of ways while remaining within the scope the invention. For example, the openings might be aligned horizontally such that the signals travel across the length of the filter, down or up an adjacent cavity, and return the length of the filter through a row of cavities with openings arranged horizontally. Moreover, the number of rows and columns of cavities and resonators can be varied while remaining within the scope of the invention. Accordingly, the arrangement of cavity openings, and openings for cross-coupling, can take on numerous variations consistent with the number of rows and columns of resonators and resonator cavities.

This concludes the description of the example embodiments. Although the present invention has been described with reference to illustrative embodiments thereof, it should be understood that numerous other modifications and embodiments can be devised by those skilled in the art that will fall within the scope and spirit of the principles of the invention. More particularly, reasonable variations and modifications of the component parts and/or arrangements of the subject combination are possible while remaining within the scope of the foregoing disclosure, drawings and the appended claims and without departing from the spirit of the invention. In addition to variations and modifications in the component parts and/or arrangements, alternative uses will also be apparent to those skilled in the art.

The description of the illustrated embodiments is not intended to limit the scope of the invention. Indeed, many variations not specifically illustrated or described are within the scope of the broader invention described herein. For example, and as noted, filters having varying delays may be utilized in combination. In other words, the nominal delay T of each filter may vary from one single terminal filter to another. Furthermore, elements other than circulators and band-pass filters may be utilized so long as they function in a manner consistent with the above description of the invention. Additionally, the direction of the transmission of signals may vary, thereby, modifying the configuration and/or the relevant components utilized, without departing from the spirit of the invention. Circulators having a greater number of terminals may be employed allowing the coupling of a greater number of filters. Recitation of the above list of alternative examples is not intended to limit the possible variations of the invention described herein.

1. An apparatus comprising a delay element including a filter having a single port.

2. The apparatus according to claim 1, including a circulator coupled to the single port of the filter.

3. The apparatus according to claim 2, wherein the circulator is a three-port circulator.

4. The apparatus according to claim 3, wherein the filter is a band-pass filter.

5. The apparatus according to claim 4, wherein the filter includes an area containing a reflective region.

6. The apparatus according to claim 5, wherein the filter includes an array of resonators arranged as a linear array.

7. The apparatus according to claim 5, wherein the filter includes an array of resonators arranged as a two dimensional array.

8. The apparatus according to claim 7, wherein the filter includes cavities in which the resonators are contained.

9. The apparatus according to claim 8, wherein the filter includes openings in the cavities in which the resonators are contained.

10. The apparatus according to claim 9, wherein the filter includes additional openings in the cavities in which the resonators are contained for cross-coupling the resonator cavities.

11. The apparatus according to claim 10, wherein the reflective region includes one or more walls of a cavity containing a resonator.

12. The apparatus according to claim 10, wherein the reflective region includes a resonator and a reflective shield.

13. The apparatus according to claim 1, wherein the filter includes a reflective region located a distance from the location of the single port about the length of the filter.

14. The apparatus according to claim 13, wherein the reflective region includes one or more walls within the filter.

15. The apparatus according to claim 14, wherein the reflective region includes a RF shield.

16. The apparatus according to claim 1, wherein the filter includes a RF shield located a distance from the location of the single port about the length of the filter, such that signals transmitted through the single port and through a length of the filter are reflected off of the shield and are transmitted back through the length of the filter to the single port.

17. The apparatus according to claim 16, including a circulator coupled to the single port of the filter.

18. The apparatus according to claim 17, wherein the circulator is a three-port circulator.

19. The apparatus according to claim 18, wherein the filter is a band-pass filter.

20. The apparatus according to claim 1, wherein the filter is a single port singly terminated band-pass filter.

21. An apparatus comprising a delay element having a first filter including a single port and a reflective region, and a first circulator coupled to the first filter at the single port.

22. The apparatus according to claim 21, wherein the first filter includes a wall located a distance from the location of the single port about the length of the filter of the single port.

23. The apparatus according to claim 21, wherein the first filter includes an RF shield.

24. The apparatus according to claim 21, wherein the first filter includes the reflective region is located a distance from the location of the single port about the length of the filter, such that input signals transmitted from the single port through the filter are then reflected off of the shield and are transmitted back through the filter to the single port.

25. The apparatus according to claim 24, wherein the first filter is a band-pass filter.

26. The apparatus according to claim 25, wherein the first filter is a single terminal band-pass filter.

27. The apparatus according to claim 21, wherein the first circulator is a three-port circulator.

28. The apparatus according to claim 27, wherein the first circulator is a three-port circulator that is arranged to be coupled to at least the first filter and a second filter.

29. The apparatus according to claim 28, including a second circulator, wherein the second circulator is arranged to be coupled to at least the first circulator.

30. The apparatus according to claim 29, wherein the second circulator is a three-port circulator.

31. The apparatus according to claim 30, wherein the second circulator is arranged to be coupled to third filter.

32. The apparatus according to claim 31, wherein the second circulator is further arranged to output a signal.

33. The apparatus according to claim 29, wherein the second circulator is arranged to be coupled to a plurality of circulators, each circulator of the plurality of circulators are connected to one another in series.

34. The apparatus according to claim 29, wherein each circulator connected to an adjacent circulator is arranged to be coupled to a respective filter, each filter having a single port.

35. The apparatus according to claim 29, wherein a plurality of circulators are connected to one another in series and a single port filter is coupled to each one of the respective circulators.

36. The apparatus according to claim 33, wherein the plurality of circulators and the plurality of filters are coupled in such a manner that input signals pass through every circulator before input signals enter one of the plurality of filters, then enter and exit each the plurality of filters as they traverse and are reflected out of each filter, passing in the reverse direction through each circulator as input signals migrate from filter to filter.

37. The apparatus according to claim 33, wherein the plurality of circulators and the plurality of filters are coupled in such a manner that input signals pass through each of the plurality of circulators in an order from first to last, then enter and exit each of the plurality of filters coupled to the plurality of circulators, passing through and being reflected out of each filter in an order opposite to that of the order in which the signal passed through the circulator to which the filter is coupled.

38. The apparatus according to claim 21, wherein the filter is a band-pass filter.

39. The apparatus according to claim 21, wherein the filter is a singly terminated band-pass filter.

40. An apparatus comprising a single-ported delay element.

41. The apparatus according to claim 40, wherein the filter includes an array of resonators arranged as a two dimensional array.

42. The apparatus according to claim 41, wherein the filter includes cavities in which the resonators are contained.

43. The apparatus according to claim 42, wherein the filter includes openings in the cavities in which the resonators are contained.

44. The apparatus according to claim 43, wherein the filter includes additional openings in the cavities in which the resonators are contained for cross-coupling the resonator cavities.

45. The apparatus according to claim 44, wherein the filter includes an area containing a reflective region.

46. The apparatus according to claim 45, wherein the reflective region includes one or more walls of a cavity containing a resonator.

47. The apparatus according to claim 45, wherein the reflective region includes a resonator and a reflective shield.

48. The apparatus according to claim 45, wherein the filter includes a reflective region located a distance from the location of the single port about the length of the filter.

49. The apparatus according to claim 45, wherein the reflective region includes one or more walls within the filter.

50. The apparatus according to claim 45, wherein the reflective region includes a RF shield.

51. The apparatus according to claim 45, wherein the filter includes a RF shield located a distance from the location of the single port about the length of the filter, such that signals transmitted through the single port and through a length of the filter are reflected off of the shield and are transmitted back through the length of the filter to the single port.

52. The apparatus according to claim 45, including a circulator coupled to the single port of the filter.

53. The apparatus according to claim 45, including a circulator coupled to the single port of the filter, wherein both the circulator and the filter are housed in a single chassis.

54. The apparatus according to claim 53, wherein the filter and the circulator are coupled together by an opening in an inner wall of the housing that houses both the circulator and the filter.

55. The apparatus according to claim 53, wherein the filter and the circulator are coupled together by a terminal.

56. The apparatus according to claim 53, wherein the circulator is a three-port circulator.

57. The apparatus according to claim 47, wherein the filter is a band-pass filter.

58. The apparatus according to claim 40, wherein the delay element is a single port singly terminated cross-coupled band-pass filter.

59. A method comprising introducing delay in a circuit using a circulator and a single port filter.

60. The method according to claim 59, including a step of inputting a signal to the circulator.

61. The method according to claim 60, including the step of outputting the signal from the circulator to the filter, wherein the signal is transmitted through a port.

62. The method according to claim 61, including a step of transmitting the signal from the port through a length of the filter.

63. The method according to claim 62, wherein the step of transmitting includes transmitting the input signal through a linear array of resonators.

64. The method according to claim 62, wherein the step of transmitting includes transmitting the input signal through a portion of a two-dimensional array of resonators.

65. The method according to claim 64, wherein the step of transmitting includes transmitting the input signal through the array of resonators in a path determined by the orientation of openings between cavities surrounding adjacent resonators.

66. The method according to claim 62, including a step of redirecting the signal using a reflective area located a distance from the location of the single port about the length of the filter.

67. The method according to claim 66, including a step of transmitting the redirected signal through at least a portion of the length of the filter to the port.

68. The method according to claim 66, including a step of transmitting the redirected signal through at least a portion of the length of filter having a two-dimensional array of resonators to the port.

69. The method according to claim 66, wherein the step of transmitting includes transmitting the input signal through the array of resonators in a path determined by the orientation of openings between cavities surrounding adjacent resonators.

70. The method according to claim 66, including a step of transmitting the signal from the filter through the port to the circulator.

71. The method according to claim 71, wherein the step of transmitting the signal through the port to the circulator occurs through the same port through which the signal is output form the circulator to the filter.

72. The method according to claim 70, including a step of outputting the signal from the first circulator.

73. A method comprising inputting a signal to a first circulator through a first port of the first circulator;
outputting the signal from the first circulator to a first filter, wherein the first circulator is coupled to the first filter via a second port of the circulator and a port of the first filter;
transmitting the signal through a length of the first filter,
reflecting the signal off of a reflective surface,
transmitting the signal back through the length of the first filter to the second port of the first circulator;
outputting the signal from the first circulator through a third port of the first circulator.

74. The method according to claim 73, wherein the step of outputting the signal from the first circulator further includes the steps of:
receiving the signal from the third port of the first circulator at a port of a second filter,
transmitting the signal through a length of the second filter;
reflecting the signal off of a reflective surface,
transmitting the signal back through the length of the second filter to the third port of the first circulator;
outputting the signal from the first circulator through the first port of the first circulator.

75. The method according to claim 74, wherein the step of inputting a signal to a first circulator through a first port of the first circulator further includes the steps of:
inputting the signal to a second circulator through a first port, wherein the second circulator is coupled to the first circulator via a second port of the second circulator and the first port of the first circulator, and
outputting the signal from the second circulator to the first circulator via the second port of the second circulator and the first port of the first circulator.

76. The method according to claim 75, wherein the step of outputting the signal from the first circulator through the first port further includes the steps of:
receiving the signal from the first circulator at a second port of the second circulator,
outputting the signal from the second circulator through a third port of the second circulator.

77. The method according to claim 76, wherein the step of outputting the signal from the second circulator through a third port of the second circulator further includes the steps of:
receiving the signal from the third port of the second circulator at a port of a third filter coupled thereto,
transmitting the signal through a length of the third filter;
reflecting the signal off of a reflective surface,
transmitting the signal back through the length of the third filter to the third port of the first circulator;
outputting the signal from the second circulator through the first port of the second circulator.

78. The method according to claim 77, wherein the step of inputting a signal to a second circulator through a first port of the second circulator includes steps of transmitting the signal through a plurality of circulators comprising the steps of:
inputting the signal to the first port of the second circulator from the second port of an adjacent circulator, and inputting the signal to a first port of each of the plurality of circulators from a second port of each of an adjacent one of said plurality of circulators, wherein each of the plurality of circulators are connected in series such that a first port of each respective circulator is connected to the second port of the adjacent circulator, and the signal is transmitted there through.

79. The method according to claim 78, wherein the step of outputting the signal from the second circulator through the first port of the second circulator includes the steps of transmitting the signal through a plurality of circulators and through a plurality of filters, each filter coupled to a respective circulator, comprising the steps of:
inputting the signal to the second port of each of said plurality of circulators from the first port of each adjacent circulator,
outputting the signal from said each of said plurality of circulators through a third port,
receiving the signal from the third port of said each of said plurality of circulators at a port of a respective one of said plurality of filters coupled thereto,
transmitting the signal to a port of coupled thereto,
transmitting the signal through a length of said one of said plurality of filters;
reflecting the signal off of a reflective surface of each of said one of said plurality of filters,
transmitting the signal back through the length of each of said one of said plurality of filters to the third port of said each of said plurality of circulators;
inputting the signal through the second port of each of the plurality of circulators,
outputting the signal from each of said plurality of circulators through the first port of said each of said plurality of circulators.
